(19) United States
(12) Patent Application Publication
(10) Pub. No.: US 2026/0252148 A1
(43) Pub. Date: Aug. 27, 2026

(54) INFORMATION HANDLING SYSTEM WITH A RADIAL TELESCOPING HINGE

(71) Applicant: DELL PRODUCTS L.P., Round Rock, TX (US)

(72) Inventors: Anthony Sanchez, Pflugerville, TX (US); Timothy Radloff, Austin, TX (US); Jason Minehart, Cedar Park, TX (US); Jui-Hung Chang, New Taipei City (TW); Hsin-Chung Chang, New Taipei City (TW)

(21) Appl. No.: 19/065,796

(22) Filed: Feb. 27, 2025

(51) Int. Cl. G06F 1/16; F16C 11/04

(52) U.S. Cl. CPC G06F 1/1681; F16C 11/04

(57) ABSTRACT

A hinge of an information handling system includes a display mounting bracket having a first arc, a base mounting bracket having a second arc, a main support including first and second channels, a side support including a third channel, and first and second sets of tension plates. A first tab of the first arc slides within the first channel and a second tab of the second arc slides within the second channel. The movement of the first tab within the first channel and the second tab within the second channel create a virtual pivot point for the hinge. The first set of tension plates is in contact with the display mounting bracket and the second set of tension plates is in contact with the base mounting bracket. The tension plates exert holding torque forces on the display mounting bracket, the base mounting, and the side support.

### FIELD OF THE DISCLOSURE

The present disclosure generally relates to information handling systems, and more particularly relates to an information handling system with a radial telescoping hinge.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A hinge of an information handling system includes a display mounting bracket having a first arc, a base mounting bracket having a second arc, a main support including first and second channels, a side support including a third channel, and first and second sets of tension plates. The first tab of the first arc slides within the first channel and the second tab of the second arc slides within the second channel. The movement of the first tab within the first channel and the second tab within the second channel create a virtual pivot point for the hinge. The first set of tension plates is in contact with the display mounting bracket and the second set of tension plates is in contact with the base mounting bracket. The tension plates exert holding torque forces on the display mounting bracket, the base mounting, and the side support.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a diagram of an information handling system according to at least one embodiment of the present disclosure;

FIG. 2 is a diagram of a portion of an information handling system according to at least one embodiment of the present disclosure;

FIGS. 3A-D are side views of a portion of an information handling system as a top portion transitions from an open position to a closed position according to at least one embodiment of the present disclosure;

FIG. 4 is a diagram of an exploded view of a hinge for an information handling system according to at least one embodiment of the present disclosure;

FIG. 5 is a diagram of a hinge of an information handling system in a closed position according to at least one embodiment of the present disclosure;

FIG. 6A is a diagram of a side view of a hinge in a closed position according to at least one embodiment of the present disclosure;

FIG. 6B is a diagram of a side view of a hinge in an open position according to at least one embodiment of the present disclosure;

FIG. 7 is a diagram of a portion of a hinge according to at least one embodiment of the present disclosure; and

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

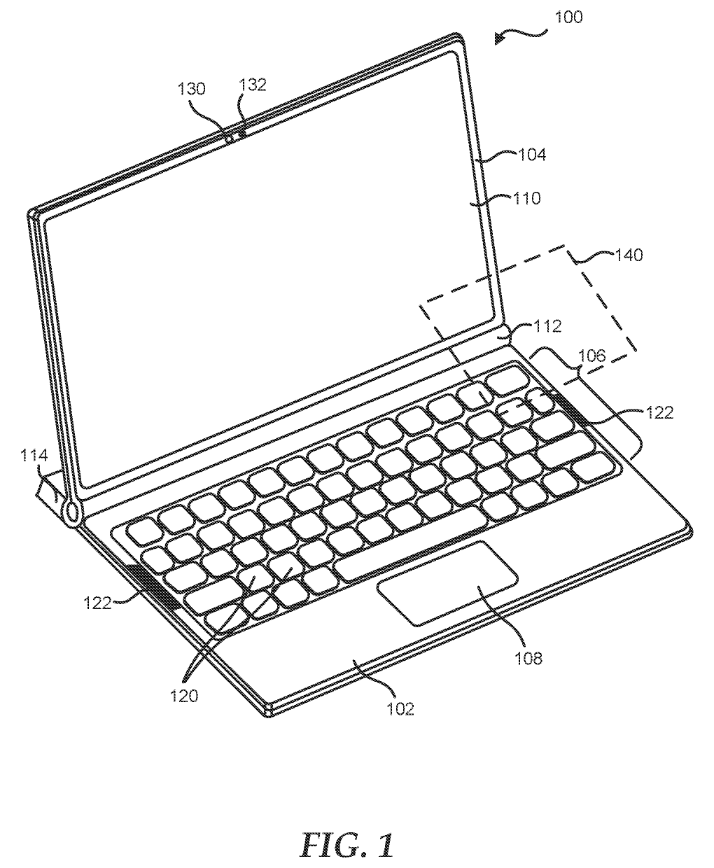

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a base portion 102 and a top portion 104. Base portion 102 includes a keyboard 106 and a touchpad 108, and top portion 104 includes a display device 110. In an example, touchpad 108 may be any suitable pointing device. Base portion 102 is connected top portion 104 via a mechanism 112, such as one or more hinges. Base portion 102 include a rear section 114. Keyboard 106 includes multiple keys 120. Base portion 102 further includes speakers 122. Top portion 104 includes a camera 130 and a microphone 132. Information handling system 100 further includes a processor 140, an ultrasound processor 142, and a vision processor 144. Information handling system 100 may include additional components without varying from the scope of the disclosure.

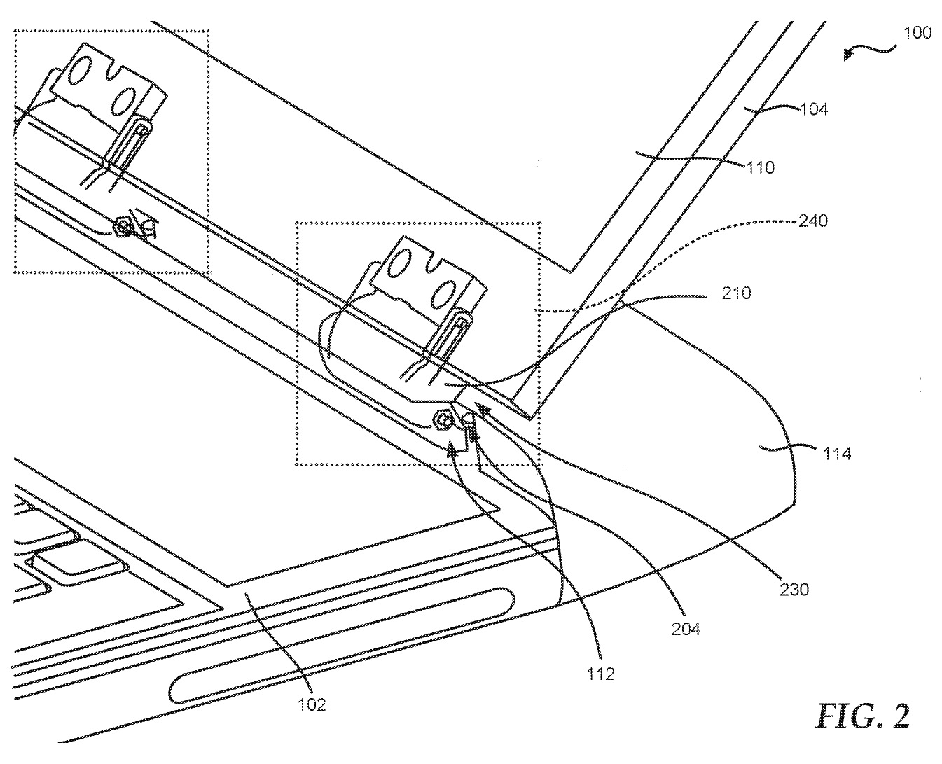

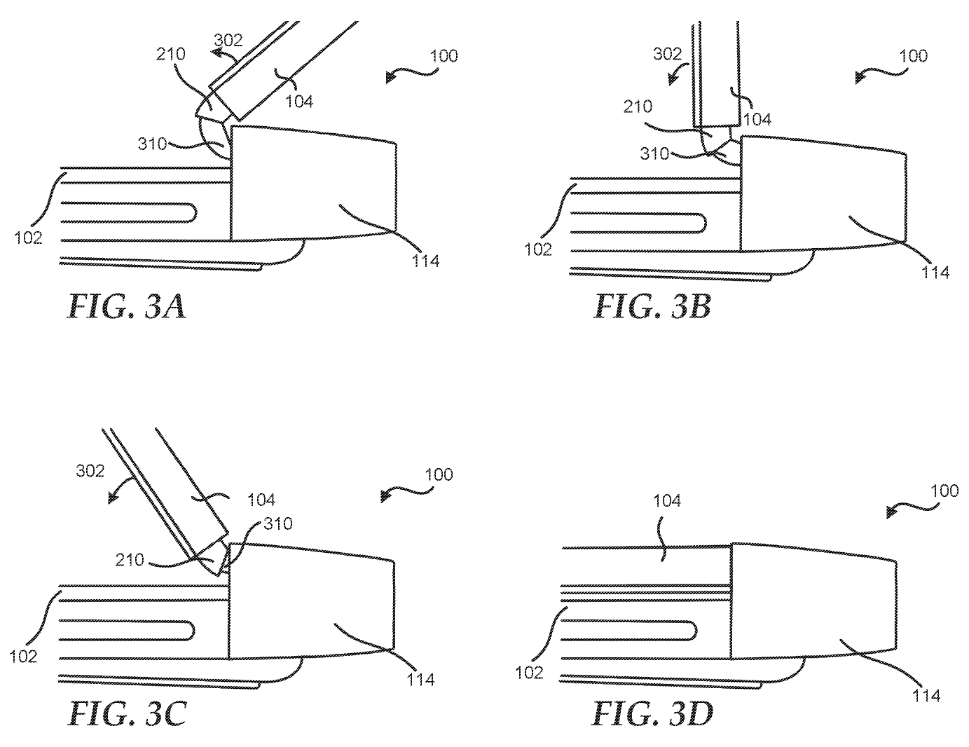

Display device 110 may include one or more light emitting devices, such as, for example, light emitting diodes (LEDs), organic LED (OLED), liquid crystal display (LCD), another type of light emitting device, or any combination thereof. A portion 140 of information handling system 100 will be described in greater detail with respect to FIGS. 2 and 3A-D below.

FIG. 2 illustrates a portion of information handling system 100 according to at least one embodiment of the present disclosure. Base portion 102 includes a rear section 114, which in turn includes a cavity 204. Top portion 104 includes a hinge up component 210 that is attached to hinge 112. In an example, rear section 114 may house different components for routing cables within base portion 102. For example, rear section 114 may include a base assembly to route a cable from display device 110 to components within base portion 102. Rear section 114 may also be a thermal shelf, such that components within the rear section provide thermal cooling to the components of base section 102.

In certain examples, hinge 112 may have any suitable design. For example, hinge 112 may have a hidden hinge design. In this example, hinge up component 210 of top portion 104 may block or hide parts of hinge 112. Hinge up component 210 may extend away from the bottom surface of top portion 104 and cover different portions of hinge 112 when the top portion is in an open position. When top portion 104 is in a closed position, as illustrated in FIG. 3D, hinge up component 210 may be inserted into cavity 204 of rear portion 202.

In an example, hinge 112 may not have a physical component, such as a rod or pin, to provide or define a rotational axis of the hinge. However, hinge 112 may have a virtual rotation point or axis 230. In this example, while top portion 104 transitions between the open position and the closed position, the top portion may rotate around rotation point or axis 230 without a physical component at the rotation axis.

FIGS. 3A-D illustrate a portion of information handling system 100 as top portion 104 transitions from the open position to the closed position according to at least one embodiment of the present disclosure. During the sequence of top portion 104 transitioning from the open position, as illustrated in FIG. 3A, to the closed position, as illustrated in FIG. 3D, the location of the top portion with respect to base portion 102 and rear section 114 changes as illustrated in FIGS. 3A, 3B, 3C, and 3D.

Referring to FIG. 3A, top portion 104 is in the open position, such that the top portion is at any suitable angle with respect to base portion 102 and rear section 114. In an example, this angle may be set by an individual using information handling system 100 so that the display device in top portion 104 may be viewed by the individual. When top portion 104 is in the open position, hinge up component 210 is outside of rear section 114 and hinge cover plate 310 may hide the hinge, such as cable 112 in FIG. 2, from being visible. is bent around a rotation point or axis of the hinge of information handling system 100. When the individual wants to close information handling system 100, the individual may exert a force on top portion 104 and this force may cause the top portion to rotate in the direction of arrow 302. Based on this force, the hinge, such as hinge 112 in FIG. 2, may rotate around a virtual point, such as virtual point 230 in FIG. 2.

Referring to FIG. 3B, top portion 104 is in an intermediate position between the open position and the closed position. When top portion 104 is in this intermediate position, both hinge up component 210 and hinge cover plate 310 may still be outside of rear section 114. As the individual continues to close information handling system 100, the individual may continue to exert the force on top portion 104 and this force may cause the top portion to rotate in the direction of arrow 304.

Referring to FIG. 3C, top portion 104 is in another intermediate position between the open position and the closed position. When top portion 104 is in this intermediate position, hinge up component 210 may still be outside of rear section 114 but most, if not all, of hinge cover plate 310 may be inside the rear section of information handling system 100. As the individual continues to close information handling system 100, the individual may continue to exert the force on top portion 104 and this force may cause the top portion to rotate in the direction of arrow 306.

Referring to FIG. 3D, top portion 104 and the hinge, such as hinge 112 in FIG. 2, are both in the closed position. When top portion 104 is in closed position, hinge up component 210 may be located inside rear section 114, such as cavity 204 in FIG. 2. Similarly, when top portion 104 is in closed position, hinge cover plate 310 may be located inside rear section 114, such as cavity 204 in FIG. 2.

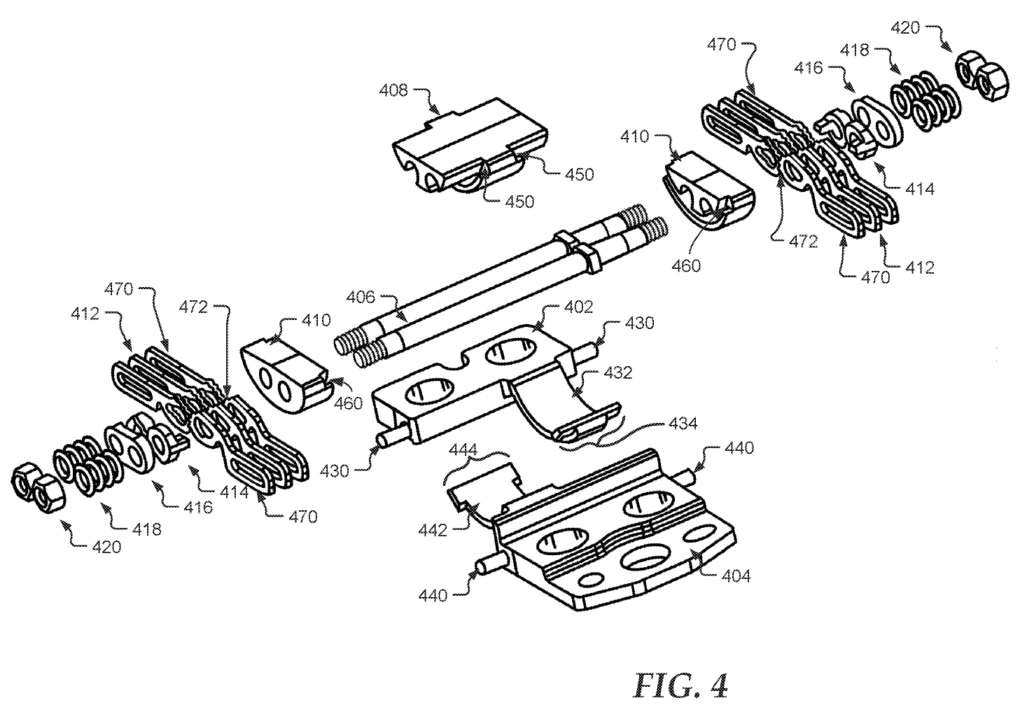

FIG. 4 illustrates an exploded view of a hinge 400 for an information handling system, such as information handling system 100 of FIG. 1, according to at least one embodiment of the present disclosure. In an example, hinge 400 may be substantially similar to hinge 112 of FIGS. 1 and 2. Hinge 400 includes a display mounting bracket 402, a base mounting bracket 404, shafts 406, a main support 408, side supports 410, tension plates 412, multiple pin cams 414, multiple cams 416, multiple spring washers 418, and multiple nuts 420. Display mounting bracket 402 includes pins 430, an arc 432, and tabs 434. Base mounting bracket 404 includes pins 440, an arc 442, and tabs 444. In an example, arcs 432 and 442 may be a C-arm design as illustrated in FIG. 4. Main support 408 includes multiple channels 450. Each side support 410 includes a respective channel 460. Each tension plate 412 includes respective channels 470 and a gear assembly 472. Hinge 400 may include additional components without varying from the scope of this disclosure.

When hinge 400 is assembled, each shaft 406 extends through corresponding holes of main support 408 and side supports 410. Additionally, each shaft 406 extends through holes of respective tension plate 412, pin cam 414, cam 416, spring washer 418, and nut 420. Display mounting bracket 402 connects with main support 408 by one tab 434 being located within one channel 450 and connects with one side support 410 by the other tab 434 being located within the corresponding channel 460 of the side support. Similarly, base mounting bracket 404 connects with main support 408 by one tab 444 being located within one channel 450 and connects with one side support 410 by the other tab 444 being located within the corresponding channel 460 of the side support. Displaying mounting bracket 402 is connected to one side of main support 408 and one side support 410, and base mounting bracket 404 is connected to the other side of main support 408 and the other side support 410.

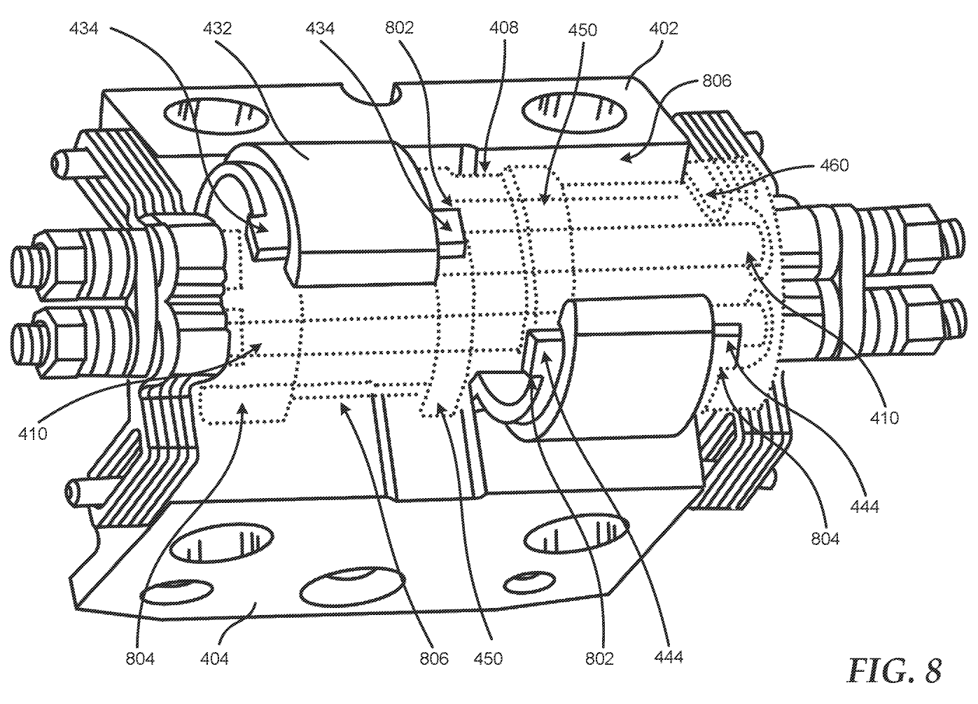

The end of each shaft 406 may extend beyond corresponding spring washer 418 such that nut 420 may be twisted onto the threaded end of the shaft. As nut 420 is rotated onto shaft 406, the nut may compress spring washer 418 and this compression force may be exerted on cam 416, pin cam 414, tension plates 412, side support 410, display mounting bracket 402, and base mounting bracket 404. In an example, the force exerted by spring washers 418 may provide or generate torque on hinge 400 as will be described below with respect to FIG. 7.

In an example, the pin of each pin cam 414 may be inserted or located within a notch of a corresponding tension plate 412. In this situation, pin cams 414 may rotate as tension plate 412 rotate. However, the interface between the surfaces of pin cams 414 and respective cams 416 may provide an auto lock or torque release feature. In an example, the auto lock or torque release feature may enable hinge 400 to close the display, such as display device 110 of top portion 104 in FIG. 1, of an information handling system at low angles. In this example, the features of pin cams 414 and cams 416 may be utilized to balance the torque profile of hinge 400. These features may flatten the torque profile to make it consistent.

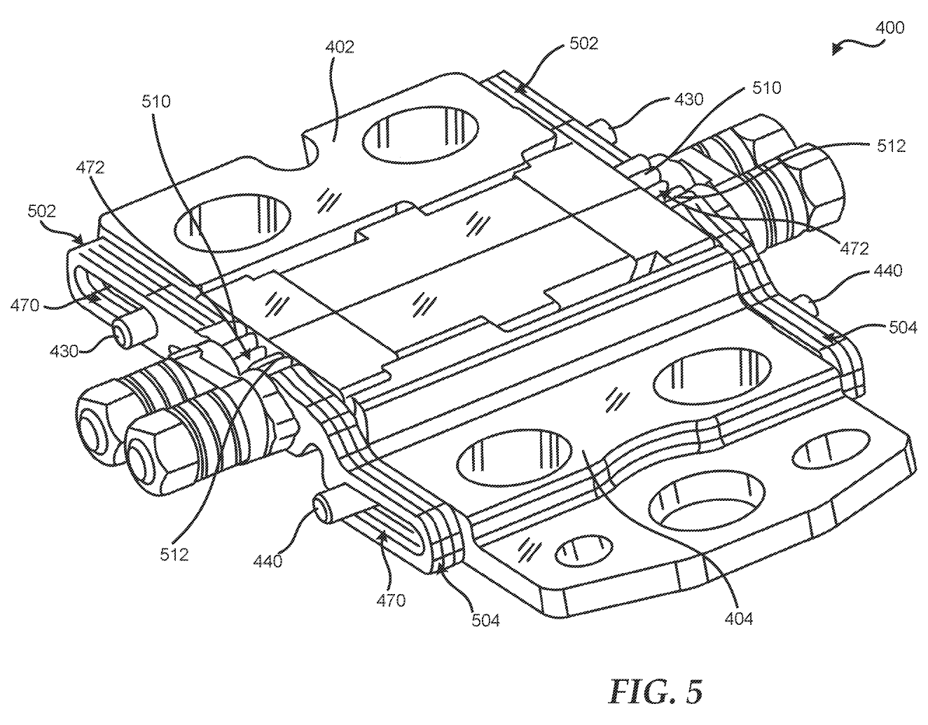

FIG. 5 illustrates hinge 400 in a closed position according to at least one embodiment of the present disclosure. As used herein, the closed position of hinge 400 refers to the position of the hinge when the display, such as display device 110 of top portion 104 in FIG. 1, is closed as illustrated in FIG. 3D. Each tension plate 412 may be separated into a display tension plate 502 and a base tension plate 504. In an example, gear assembly 472 is formed by the combination of pin and slot linkage 510 on display tension plate 502 and pin and slot linkage 512 on tension plate 504. In this example, pin and slot linkages 510 and 512 are utilized to drive the position of display mounting bracket 402 and base mounting bracket 404 for hinge 402.

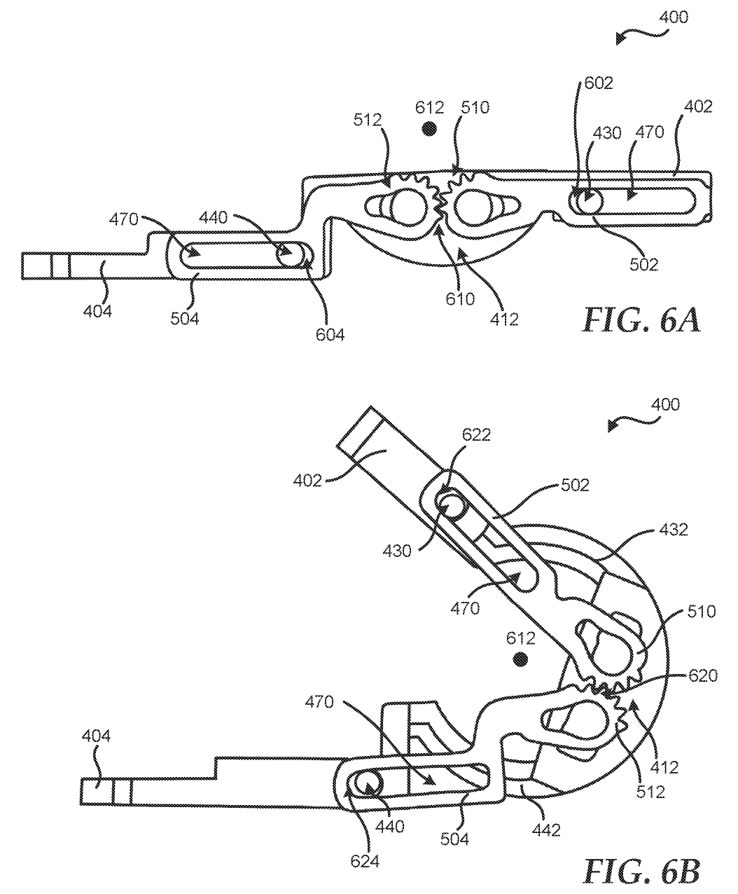

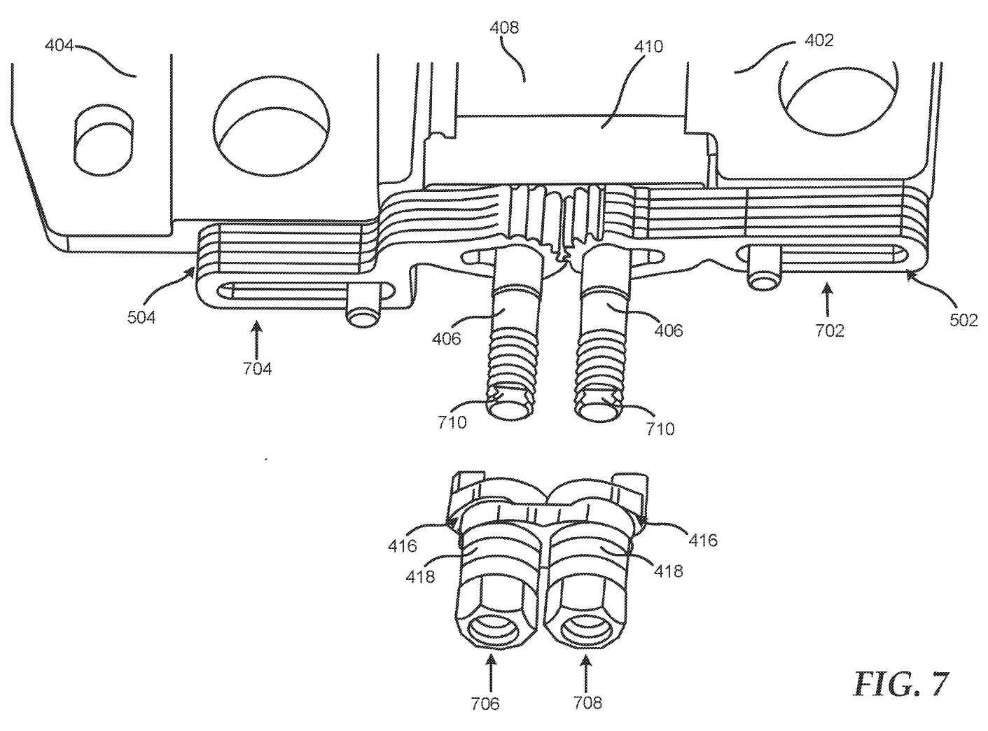

As illustrated in FIG. 5, each pin 430 may extend through respective channels 470 of display tension plates 502 and each pin 440 may extend through respective channels 470 of base tension plates 504. In an example, pins 430 and 440 may slide within channels 470 as hinge 400 transitions between the closed and open positions as will be described with respect to FIGS. 6A and 6B.

FIGS. 6A and 6B illustrate a side view of hinge 400 as the hinge transitions from the closed position to the open position according to at least one embodiment of the present disclosure. During the sequence of hinge 400 transitioning from the closed position, as illustrated in FIG. 6A, to the open position, as illustrated in FIG. 6B, the angle of display mounting bracket 402 with respect to base mounting bracket 404 changes as illustrated in FIGS. 6A and 6B.

Referring to FIG. 6A, hinge 400 is in the closed position, such that channel 470 in tension plate 502 is substantially parallel with channel 470 in tension plate 504. While hinge 400 is in the closed position, display device 110 in top portion 104 is located substantially close to keyboard 106 of base portion 102 of FIG. 1, such that the top portion 104 is in the closed position as illustrated in FIG. 3D. Additionally, when hinge 400 is in the closed position, portions 610 of pin and slot linkages 510 and 512 may be in contact with each other.

As shown in FIGS. 6A and 6B, a virtual pivot point or axis 612 is located outside of hinge 400. Virtual pivot point or axis 612 is substantially similar to virtual pivot point or axis 230 of FIG. 2. In an example, portions 610 of pin and slot linkages 510 and 512 may be one end of gear assembly 472 and portions 620 may be the opposite end of the gear assembly. In this example, the movement of hinge 400 is gear driven with pin and slot linkages 510 and 512 that combine with arcs 432 and 442 to drive the position of mounting brackets 402 and 404.

While hinge 400 is in the closed position, pin 430 of display mounting bracket 402 may be located substantially near end 602 of channel 470 in tension plate 502. Similarly, while hinge 400 is in the closed position, pin 440 of base mounting bracket 404 may be located substantially near end 604 of channel 470 in tension plate 504. As hinge 400 rotates or transitions from the closed position to the open position, pin 430 may move along channel 470 of tension plate 502 from end 602 towards end 622 as illustrated in FIG. 6B. Similarly, as hinge 400 rotates or transitions from the closed position to the open position, pin 440 may move along channel 470 of tension plate 504 from end 604 towards end 624 as illustrated in FIG. 6B.

Referring to FIG. 6B, hinge 400 is in the open position, such that channel 470 in tension plate 502 is at any suitable angle with respect to channel 470 in tension plate 504. In an example, this angle may be set by an individual using information handling system 100 of FIG. 1 so that display device 110 in top portion 104 in FIG. 1 may be viewed by the individual. Additionally, when hinge 400 is in the closed position, portions 620 of pin and slot linkages 510 and 512 may be in contact with each other.

As illustrated in FIGS. 6A and 6B, portion 610 may be one extreme of pin and slot linkages 510 and 512 and portion 620 may be the other extreme of pin and slot linkages 510 and 512. When hinge 400 is in the open position, pin 430 of display mounting bracket 402 may be located substantially near end 622 of channel 470 in tension plate 502. Similarly, while hinge 400 is in the closed position, pin 440 of base mounting bracket 404 may be located substantially near end 624 of channel 470 in tension plate 504.

As shown in FIG. 6B, C-shaped arc 432 of display mounting bracket 402 and C-shaped arc 442 of base mounting bracket 404 may create virtual pivot point or axis 612. In an example, gear assembly 472 may cause/enable display mounting bracket 402 to telescope around virtual pivot point 612. In certain examples, the majority of arc 432 may pull or slide out of channels 460 within side supports 410 and pull or slide out of channels 450 within main support 408 during the transition of hinge 400 from the closed position to the open position. Similarly, the majority of arc 442 may pull or slide out of channels 460 within side supports 410 and pull or slide out of channels 450 within main support 408 during the transition of hinge 400 from the closed position to the open position. This movement of arcs 432 and 442 with respect to main support 408 and side supports 410 create the rotation of hinge 400 around virtual pivot point or axis 612.

FIG. 7 illustrates a portion of hinge 400 according to at least one embodiment of the present disclosure. As shown in FIG. 7, different forces 702, 704, 706, and 708 may be exerted on components on hinge 400 to create torque within the hinge. For brevity and clarity, only components on one side of hinge 400 as illustrated and described with respect to FIG. 7. However, corresponding forces that are substantially equal to forces 702, 704, 706, and 708 may be applied to the other edge of hinge 400 without varying from the scope of this disclosure.

When the display mounting bracket 402 is moved in response to the user adjusting the display angle of display device 110, pin 430 applies a force normal to the length of channel 470 in tension plate 502. For example, pin 430 may apply a moment load to tension plates 502. In an example, this moment load may overcome the torque that is inherent in the press fit of tension plates 502 and 504 over shafts 406. In certain examples, tension plates 502 mesh with tension plates 504 through the gear mesh of gear assembly 472. This meshing of tension plates 502 and 504 may effectively cause rotation of the tension plates around their corresponding shaft 406 and contribute to the motion of display device 110. Additionally, the meshing of tension plates 502 and 504 may contribute to the total moment within hinge 400 that holds display device 110 in a static position after user motion has stopped.

In certain examples, the torque produced by tension plates 502 and 504 may be a main source of torque to resist the rotation of hinge 400 from the closed position to the open position and from the open position to the closed position. Additionally, this torque may hold display mounting bracket 402, top portion 104 and display device 110 of FIG. 1, in any intermediate position between the closed position and the open position.

In an example, a secondary or minor source of torque on hinge 400 may be provided by spring washers 418 and cams 416. In certain examples, a portion of a load or secondary torque may result from how the surfaces of cams 416 interact with each other and how the cams further compress spring washers 418. The torque from spring washers 418 and cams 416 may be created or generated based on forces exerted by the spring washers in the directions of arrows 706 and 708. These forces in the directions of arrows 706 and 708 may be exerted on cams 416, tension plates 502 and 504, display mounting bracket 402, base mounting bracket 404, side support 410, and main support 408. In certain examples, the secondary torque source from spring washers 418 may fine tune the total torque output and stabilize the torque profile for hinge 400. The amount of torque generated by the interference fit of tension plates 502 and 504 and shafts 406 may be any suitable percentage of the total amount of torque, such as 55%, 60%, 65%, or the like. The amount of torque generated by spring washers 418 may be any suitable percentage of the total amount of torque, such as 45%, 40%, 35%, or the like.

As illustrated in FIG. 7, each shaft 406 includes a flat portion 710 at each end of the shaft. In an example, flat portions 710 enable a hinge cover plate, such as cover plate 310 in FIGS. 3A-D, to snap fit on shafts 406 of hinge 400. In certain examples, the cover plate may extend along the curved side of main support 408 and side supports 410 to hide hinge 400 from view when the hinge is in the open position.

FIG. 8 illustrates hinge 400 in an open position according to an embodiment of the present disclosure. As illustrated in FIG. 8, each of channels 450 of main support 408 includes a respective stop 802 and each channel 460 of side support 410 includes a respective stop 804. Additionally, main support 408 also includes stops 806. In certain examples, stops 802 and 804 may control the maximum distance hinge 400 may rotate towards the open position. Similarly, stops 806 may control the maximum distance hinge 400 may rotate towards the closed position. In another example, pins 430 and 440 may contact respective ends 602 and 604 within channels of corresponding tension plates 502 and 504 to control the maximum distance hinge 400 of FIG. 6A may rotate towards both the closed position. Additionally, display device 110 and top portion 104 may be fully closed against base portion 102 of information handling system 100 of FIG. 1 to control the maximum distance hinge 400 may rotate towards both the closed position.

In an example, when hinge 400 has rotated a maximum amount toward the open position, one of tabs 434 of display mounting bracket 402 may be placed in physical communication or contact with stop 802 of side support 410. Additionally, when hinge 400 has rotated a maximum amount toward the open position, the other tab 434 may be placed in physical communication or contact with stop 804 of main support 802. In certain examples, hinge 400 may have a hard stop for the open position at any suitable angle measured with respect to the closed position, such as 130°, 135°, 140°, or the like. The contact between tab 434 and stop 802 and the contact between tab 434 and stop 804 create the end point of the rotation of hinge 400 toward the open position. Based on the end point of rotation, stops 802 and 804 prevents pin 430 of display mounting bracket 402 from physically contacting end 612 of channel 470 in tension plate 502. Similarly, stops 802 and 804 prevents pin 440 of base mounting bracket 404 from physically contacting end 614 of channel 470 in tension plate 504.

When hinge 400 has rotated a maximum amount toward the closed position, a main section of arc 432 may be placed in physical communication or contact with one of the stops 806 of main supports 408. Additionally, when hinge 400 has rotated a maximum amount toward the closed position, a main section of arc 442 may be placed in physical communication or contact with the other stop 406 of main support 408. The contact between the main section of arc 432 and stop 806 prevents pin 430 of display mounting bracket 402 from physically contracting end 602 of channel 470 in tension plate 502. Similarly, stop 806 prevents pin 440 of base mounting bracket 404 from physically contacting end 604 of channel 470 in tension plate 504. In another example, pins 430 and 440 may contact respective ends 602 and 604 within channels of corresponding tension plates 502 and 504 to control the maximum distance hinge 400 of FIG. 6A may rotate towards both the closed position. Additionally, display device 110 and top portion 104 may be fully closed against base portion 102 of information handling system 100 of FIG. 1 to control the maximum distance hinge 400 may rotate towards both the closed position.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A hinge of an information handling system, the hinge comprising:
a display mounting bracket having a first arc;
a base mounting bracket having a second arc;
a main support including first and second channels, wherein a first tab of the first arc slides within the first channel and a second tab of the second arc slides within the second channel, wherein a movement of the first tab within the first channel and the second tab within the second channel create a virtual pivot point for the hinge;
a side support including a third channel, wherein a third tab of the first arc slides within the third channel; and
first and second sets of tension plates, wherein the first set of tension plates is in contact with the display mounting bracket and the second set of tension plates is in contact with the base mounting bracket, wherein the first and second sets of tension plates exert first and second holding torque forces on the display mounting bracket, the base mounting bracket, and the side support.

2. The hinge of claim 1, wherein the virtual pivot point is located away from the hinge.

3. The hinge of claim 1, wherein the first set of tension plates includes a first pin and slot linkage, and the second set of tension plates includes a second pin and slot linkage, wherein the first and second pin and slot linkages drive a position of the display mounting bracket and the base mounting bracket.

4. The hinge of claim 1, wherein a rotation of the hinge towards an open position stops when the first tab is placed in contact with a first end of the first channel.

5. The hinge of claim 4, wherein the rotation of the hinge towards a closed position stops when the first tab is placed in contact with a second end of the first channel.

6. The hinge of claim 1, wherein the display mounting bracket includes a pin that extends through a channel of the first set of tension plates, wherein the pin transitions from a first end of the channel to a second end of the channel as the hinge rotates from a closed position to an open position.

7. The hinge of claim 1, furthering including: a spring washer and a cam to a third holding torque force on the display mounting bracket, the base mounting bracket, and the side support, wherein the third holding torque force provides a stabilized torque profile for the hinge.

8. The hinge of claim 1, wherein the hinge rotates around the virtual pivot point in response to a movement force greater than the first and second holding torque forces being exerted on the display mounting bracket.

9. The hinge of claim 8, wherein the first and second holding torque forces hold the hinge in a position when the movement force is removed from the display mounting bracket.

10. An information handling system comprising:
a top portion including a display device;
a bottom portion coupled to the top portion, the bottom portion including a processor; and
a hinge connected to both the top portion and the bottom portion, the hinge includes:
a display mounting bracket having a first arc, wherein the display mounting bracket is connected to the top portion;
a base mounting bracket having a second arc, wherein the base mounting bracket is connected to the bottom portion;
a main support including first and second channels, wherein a first tab of the first arc slides within the first channel and a second tab of the second arc slides within the second channel, wherein a movement of the first tab within the first channel and the second tab within the second channel create a virtual pivot point for the hinge;
a side support including a third channel, wherein a third tab of the first arc slides within the third channel; and
first and second sets of tension plates, wherein the first set of tension plates is in contact with the display mounting bracket and the second set of tension plates is in contact with the base mounting bracket, wherein the first and second sets of tension plates exert first and second holding torque forces on the display mounting bracket, the base mounting bracket, and the side support.

11. The information handling system of claim 10, wherein the virtual pivot point is located away from the hinge.

12. The information handling system of claim 10, wherein the first set of tension plates includes a first pin and slot linkage, and the second set of tension plates includes a second pin and slot linkage, wherein the first and second pin and slot linkages drive a position of the display mounting bracket and the base mounting bracket.

13. The information handling system of claim 10, wherein a rotation of the hinge towards an open position stops when the first tab is placed in contact with a first end of the first channel.

14. The information handling system of claim 13, wherein the rotation of the hinge towards a closed position stops when the first tab is placed in contact with a second end of the first channel.

15. The information handling system of claim 10, wherein the display mounting bracket includes a pin that extends through a channel of the first set of tension plates, wherein the pin transitions from a first end of the channel to a second end of the channel as the hinge rotates from a closed position to an open position.

16. The information handling system of claim 10, furthering including: a spring washer and a cam to a third holding torque force on the display mounting bracket, the base mounting bracket, and the side support, wherein the third holding torque force provides a stabilized torque profile for the hinge.

17. The information handling system of claim 10, wherein the hinge rotates around the virtual pivot point in response to a movement force greater than the first and second holding torque forces being exerted on the display mounting bracket.

18. The information handling system of claim 17, wherein the first and second holding torque forces hold the hinge in a position when the movement force is removed from the display mounting bracket.

19. An information handling system comprising:
a top portion including a display device;
a bottom portion coupled to the top portion, the bottom portion including a processor;
a hinge connected to both the top portion and the bottom portion, the hinge includes:
a display mounting bracket having a first arc, wherein the display mounting bracket is connected to the top portion;
a base mounting bracket having a second arc, wherein the base mounting bracket is connected to the bottom portion;
a main support including first and second channels, wherein a first tab of the first arc slides within the first channel and a second tab of the second arc slides within the second channel, wherein a movement of the first tab within the first channel and the second tab within the second channel create a virtual pivot point for the hinge;
a side support including a third channel, wherein a third tab of the first arc slides within the third channel; and
first and second sets of tension plates, wherein the first set of tension plates is in contact with the display mounting bracket and the second set of tension plates is in contact with the base mounting bracket, wherein the first and second sets of tension plates exert first and second holding torque forces on the display mounting bracket, the base mounting bracket, and the side support; and
a hinge cover plate snap fitted on the hinge.

20. The information handling system of claim 19, wherein a rotation of the hinge towards an open position stops when the first tab is placed in contact with a first end of the first channel, and wherein the rotation of the hinge towards a closed position stops when the first tab is placed in contact with a second end of the first channel.
